(19) United States
(12) Patent Application Publication
(10) Pub. No.: US 2003/0065753 A1
(43) Pub. Date: Apr. 3, 2003

(54) Information processing apparatus and network configuration method

(75) Inventors: Satoru Taninaka, Tokyo (JP); Atsushi Koyanagi, Tokyo (JP)

Correspondence Address: FOLEY & LARDNER, 2029 CENTURY PARK EAST, SUITE 3500, LOS ANGELES, CA, 90067

(73) Assignee: KABUSHIKI KAISHA TOSHIBA

(21) Appl. No.: 10/215,072

(22) Filed: Aug. 7, 2002

(30) Foreign Application Priority Data
Sep. 28, 2001 (JP) 2001-304572

(51) Int. Cl. G06F 15/177

(52) U.S. Cl. 709/220; 709/224

(57) ABSTRACT

An information processing apparatus which is capable of performing communication via a network and acquiring, from a server connected to the network, configuration information for utilizing the network, the apparatus comprising an instruction unit configured to generate an acquisition instruction for acquiring the configuration information upon an operation by a user, a search unit configured to detect the server on the network according to the acquisition instruction, and an acquisition device configured to acquire the configuration information from the detected server.

### CROSS-REFERENCE TO RELATED APPLICATIONS

This application is based upon and claims the benefit of priority from the prior Japanese Patent Application No. 2001-304572, filed Sep. 28, 2001, the entire contents of which are incorporated herein by reference.

### BACKGROUND OF THE INVENTION

1. Field of the Invention

The present invention relates to an information processing apparatus capable of being connected to a network and a network configuration method with a function of automatically acquiring network configuration information.

2. Description of the Related Art

Recently, networks such as a wired LAN using Ethernet and a wireless LAN based on IEEE 802.11 standards, are commonly used. When an information processing apparatus, for example a personal computer, is to be connected to a particular network, a network configuration operation suitable for the particular network environment is necessary, and the user is required to perform such an operation.

One known scheme for acquiring information for enabling a personal computer (referred to also as “client”) to utilize a network to which the personal computer is to be connected is DHCP (Dynamic Host Configuration Protocol). DHCP is based on a BOOT protocol. The client is configured based on the network configuration necessary to use the DHCP protocol. Thus, when the personal computer is activated, the DHCP protocol operates and the client automatically receives an IP (Internet Protocol) address from a DHCP server connected to the network.

However, in the case of the conventional personal computer having a Windows operating system, each time the network environment changes (i.e., each time the personal computer is to be connected to another network) the user may be required to open a network configuration applet and reconfigure the personal computer to use the new network environment.

Such network configuration operations assume some specific knowledge on the user's part. Users who are not experienced with personal computers may find it very difficult and time-consuming to perform such operations. For example, when reconfiguring the personal computer to use a new network configuration, some inexperienced users may find it difficult to determine which configuration parameters require changing and where those parameters are located on the screen.

Although the automatic acquisition setting in the DHCP protocol is convenient, the automatic acquisition is not necessarily required in some situations. Possible network environments include a network environment with the DHCP server and a network environment using a fixed IP address. The network environment may change. For example, the network environment using a fixed IP address may change to a network environment with the DHCP server, or vice versa. As another example, one network environment may require a particular IP address and a different network environment may require a different IP address. In either case, the user may be required to open a network configuration applet and reconfigure the personal computer to use the new network environment.

In addition, in the reconfiguration processes described above, the user is unable to obtain real-time information about the current state (i.e., the progress) of the automatic network configuration acquisition process. Instead, the user must execute Window commands (for example, “winipcfg” and “ipconfig”) in order to confirm that the network configuration information has successfully been acquired.

### BRIEF SUMMARY OF THE INVENTION

The present invention is directed to an information processing apparatus capable of being connected to a network and a network configuration method with a function of automatically acquiring network configuration information that substantially obviates one or more of the problems described above.

According to an embodiment of the present invention, an information processing apparatus is described which is capable of performing communication via a network and acquiring, from a server connected to the network, configuration information for utilizing the network.

The apparatus comprises an instruction unit configured to generate an acquisition instruction for acquiring the configuration information upon an operation by a user. The apparatus includes a search unit configured to detect the server on the network according to the acquisition instruction. The apparatus further includes an acquisition device configured to acquire the configuration information from the detected server.

### BRIEF DESCRIPTION OF THE SEVERAL VIEWS OF THE DRAWING

The accompanying drawings, which are incorporated in and constitute a part of the specification, illustrate embodiments of the present invention and, together with the general description given above and the detailed description of the embodiments given below, serve to explain the principles of the present invention in which:

FIG. 1 shows a schematic structure of an information processing apparatus according to embodiments of the present invention, and also shows connection between the apparatus and a network;

FIG. 2 is a block diagram showing a detailed structure of the information processing apparatus, according to embodiments of the invention;

FIG. 3 is a flowchart illustrating a processing operation for acquiring network configuration information, according to embodiments of the invention;

FIGS. 4A, 4B, 4C and 4D show examples of display screen images while network configuration information is being acquired, according to embodiments of the invention;

FIG. 5 is a flowchart illustrating a processing operation for acquiring network configuration information, according to further embodiments of the invention;

FIG. 6 is a flowchart illustrating a processing operation for acquiring network configuration information, according to further embodiments of the invention;

FIG. 7 is a flowchart illustrating a processing operation for acquiring network configuration information, according to further embodiments of the invention;

FIG. 8 is a flowchart illustrating a processing operation for acquiring network configuration information, according to further embodiments of the invention; and

FIG. 9 is a flowchart illustrating a processing operation for acquiring network configuration information, according to further embodiments of the invention.

### DETAILED DESCRIPTION OF THE INVENTION

An information processing apparatus and network configuration method according to embodiments of the present invention will now be described with reference to the accompanying drawings. According to the embodiments, a personal computer is described as an example of the information processing apparatus. However, embodiments of the present invention may also be employed with other information processing apparatuses such as, but not limited to, an e-mail apparatus and an Internet browser apparatus.

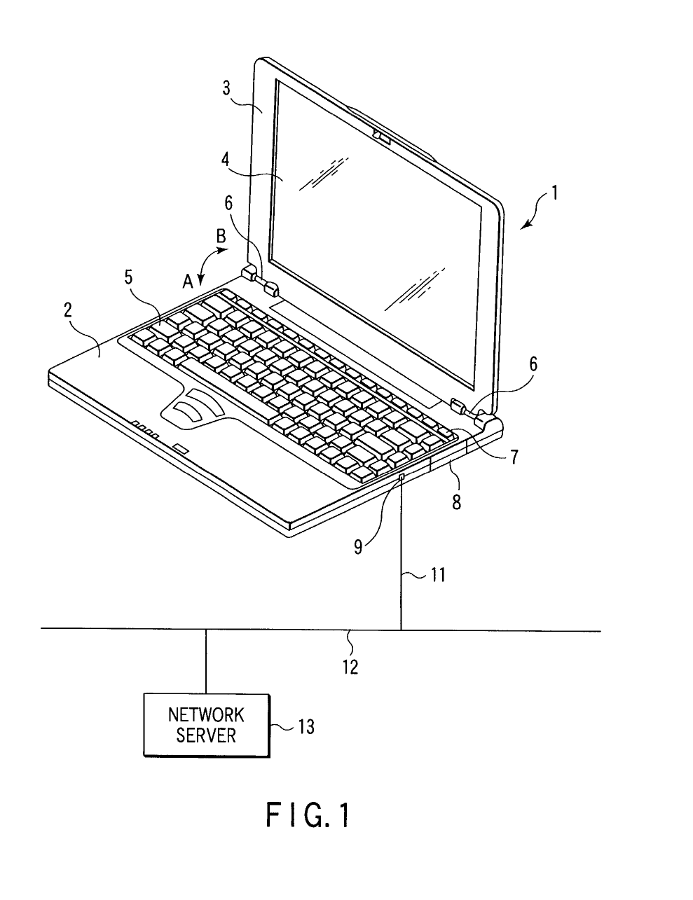

FIG. 1 is a perspective view showing an external appearance of a personal computer 1, according to an embodiment of the present invention. The personal computer 1 comprises a body case 2, a display case 3, a display device 4 such as an LCD, and a keyboard 5. The body case 2 has a power button (not shown) and has the keyboard 5 disposed on its upper surface. The body case 2 and display case 3 are coupled by means of hinge members 6. The display case 3 supports a peripheral portion of the display device 4 such that a display area of the display device 4 is made visible. The display case 3 is movable in directions of a double-headed arrow A-B on the hinge portions 6. Specifically, the display case 3 is movable between a closed position where the display case 3 covers the keyboard 5 and an opened position where the keyboard 5 may be used.

The keyboard 5 has character input keys and various function keys. The keyboard 5 also has an instruction button 7 for automatically acquiring configuration information for utilizing a particular network. As an example, the instruction button 7 may be implemented as one of the function keys.

The body case 2 has a card slot 8 and a network connection terminal 9 at a side portion thereof.

The network connection terminal 9 is connected to a network 12 via a network cable 11 such as an Ethernet cable. A network server (DHCP server) 13 is connected to the network 12. The network server 13 stores network configuration information such as an IP address, a gateway address and a subnet mask, which are preset by a network manager, etc.

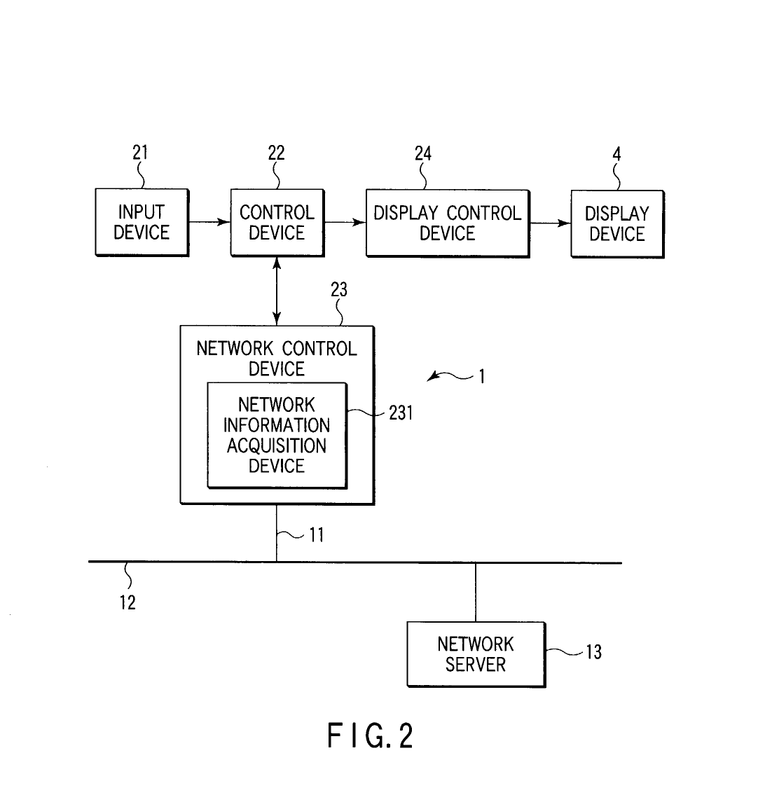

FIG. 2 shows functions performed by the personal computer 1. These functions may be implemented, for example, as electronic circuits, hardware, software, firmware or combinations thereof. The personal computer 1 comprises an input device 21, a control device 22, a network control device 23, a display control device 24, and the display device 4.

The input device 21 receives an input from the keyboard 5, a mouse, etc. and delivers a signal to the control device 22. The control device 22 controls the entirety of the personal computer 1. The control device 22 executes various programs loaded in a memory (not shown), and controls the network control device 23 and display control device 24.

The network control device 23 includes a network information acquisition device 231 and achieves a control associated with the network 12. The network control device 23 activates a network configuration utility program when the instruction button 7 on the keyboard 5 has been depressed or otherwise selected, and controls the network information acquisition device 231 to acquire network configuration information from the network server 13.

The display control device 24 controls the display on the display device 4. For example, when the network configuration is performed, the display control device 24 causes the display device 4 to display information relating to the network configuration. The display device 4 displays various types of information according to the control by the display control device 24. During the network configuration, the display device 4 displays the state of the personal computer for which the network configuration is being performed.

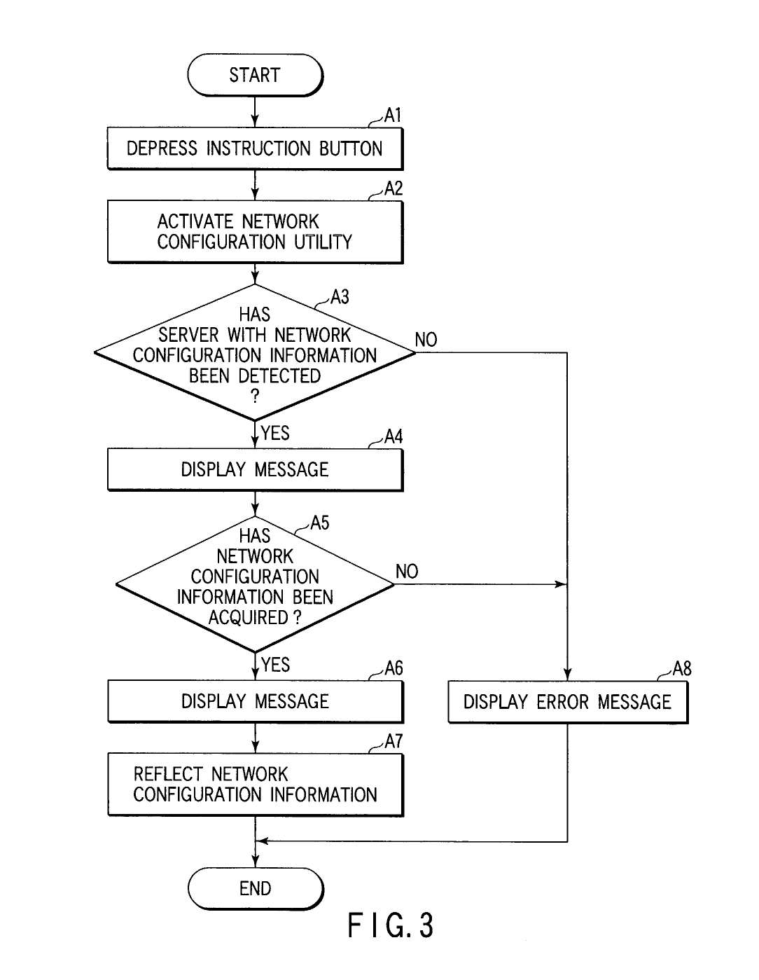

A process of effecting network configuration by automatically acquiring network configuration information will now be described with reference to the flow chart shown in FIG. 3.

When the personal computer 1 is connected to the network 12 over the network cable 11 (as shown in FIGS. 1 and 2) and network configuration information is to be automatically acquired, the instruction button 7 on keyboard 5 is depressed (step A1).

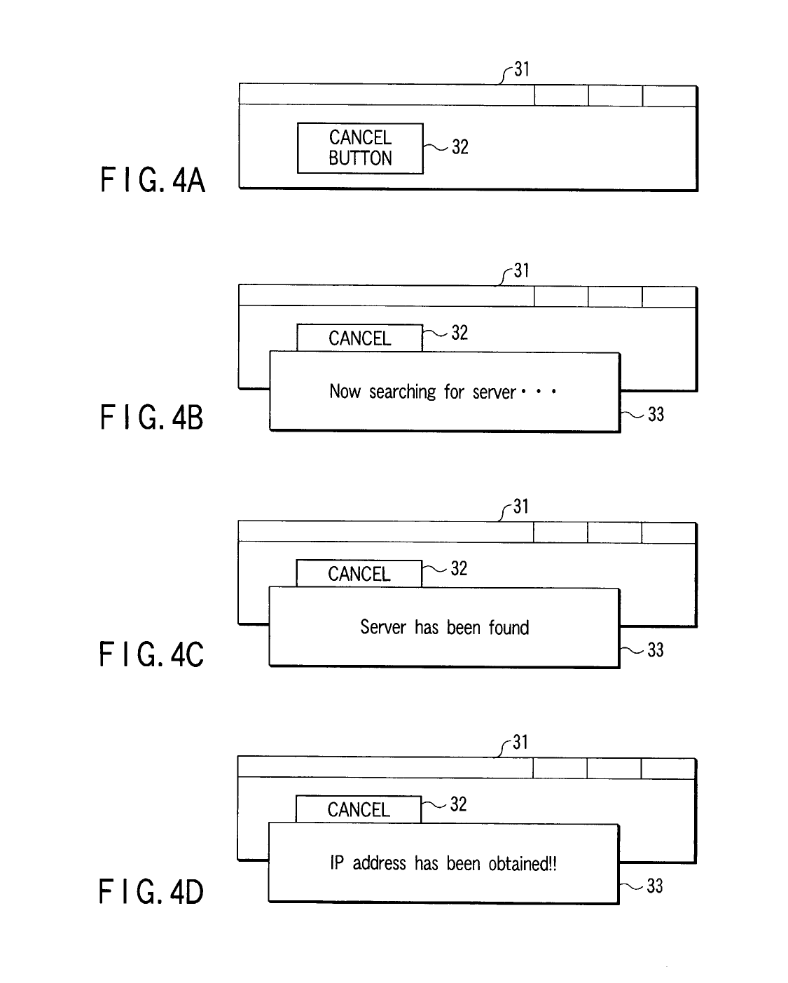

When the instruction button 7 is depressed, the network control device 23 activates the network configuration utility program upon instruction from the control device 22 (step A2). A search for network server 13 is then initiated by the network control device 23 in order to acquire network configuration information. The network control device 23 also causes the display device 4 to display a cancel button 32, for example in a window 31, as shown in FIG. 4A. If network traffic is heavy and responses from the network server 13 are not optimal, the cancel button 32 may be depressed to suspend the search for the network server 13. Thus, the network configuration information will not be acquired if the cancel button 32 is selected.

As discussed above, once the network configuration utility program is activated, the network control device 23 starts a search operation for finding the network server 13 having the network configuration information (step A3). While the network control device 23 is searching for the network server 13, the network control device 23 sends a signal to the control device 22 to indicate that the network control device 23 is searching for the network server 13. In addition, the control device 22 monitors the current state of the network control device 23 and causes the display device 4 to display a message such as “Now searching for server” in a window 33, as shown in FIG. 4B.

If the network control device 23 has detected the network server 13 having the network configuration information (“YES” in step A3), the network control device 23 sends to the control device 22 a signal to the effect that the network server 13 has been detected. In addition, the control device 22 instructs the display control device 24 to cause the display device 4 to display a message such as “Server has been found” in the window 33, as shown in FIG. 4C (step A4).

The server detection/non-detection signal sent from the network control device 23 to the control device 22 may be a 1-bit signal. For example, when the 1-bit signal is “0”, non-detection of the server is indicated. When the 1-bit signal is “1”, detection of the server is indicated.

Once the network server 13 has been detected, the network control device 23 activates the network information acquisition device 231 to acquire the network configuration information from the network server 13 (step A5). If the network configuration information has successfully been obtained from the network server 13 in step A5, the display device 4 displays a message such as “IP address has been obtained!!” in the window 33, indicating that the network configuration information has been acquired, as shown in FIG. 4D (step A6). The obtained network configuration information is reflected in the personal computer 1 (step A7). Thus, the personal computer 1 may now be logged in to the network 12.

If the network server 13 having the network configuration information failed to be found in step A3, or if the network configuration information failed to be obtained from the network server 13 in step A5, an error message is displayed (step A8) and the process is ended.

According to embodiments of the present invention, the information processing apparatus has a network communication function and is capable of acquiring network configuration information (i.e., information required for utilizing the network) from a server connected to the network. The information processing apparatus comprises a power button for starting a power supply to provide power to the apparatus. The information processing apparatus further comprises an instruction button for initiating acquisition of configuration information for network connection from a server, after power has been supplied to the information processing apparatus by the power button. The information processing apparatus further comprises acquisition means for detecting the server on the network and acquiring the configuration information, after the instruction button has been depressed or otherwise selected.

Specifically, the instruction button 7 is provided on the keyboard 5. When the instruction button 7 is depressed or otherwise selected, the network configuration information is automatically acquired from the network server 13. Thus, the user can acquire the network configuration information simply by depressing the instruction button 7.

In the embodiments of the present invention described above, the network configuration information can be obtained simply by depressing the instruction button. Accordingly, there is no need to perform the configuration from the network configuration applet on the control panel. Thus, even users who are not familiar with operating systems (OS) can easily acquire the network configuration information.

Furthermore, as discussed above, while the network control device 23 is performing the network configuration information acquiring process, the current state of the process is displayed on the display device 4. Thus, real-time information about the progress (i.e., acquisition/non-acquisition of the network configuration information) of the automatic network configuration acquisition process is advantageously provided to the user.

Although embodiments of the present invention described above are directed to the automatic acquisition of network configuration information in a wired network, embodiments of the invention are similarly applicable to wireless LANs such as, but not limited to, a wireless LAN using the IEEE 802.11 standard. The IEEE 802.11b standard is a radio communication standard which uses the ISM (Industry Science Medical) band of 2.4 GHz. In this communication standard, DSSS (Direct Sequence Spread Spectrum) is used as a spread spectrum method, and communication can be performed at a maximum rate of 11 Mbps.

In order to communicate with a wireless LAN, the personal computer 1 may be equipped with an internal wireless LAN function, or may be adapted to receive a network communication card, i.e. a wireless LAN card, in the card slot 8 of the personal computer 1.

Further embodiments of the information processing apparatus will now be described. The same features as those described in relation to earlier embodiments will be indicated by the same reference numerals and a detailed description of those features will be omitted.

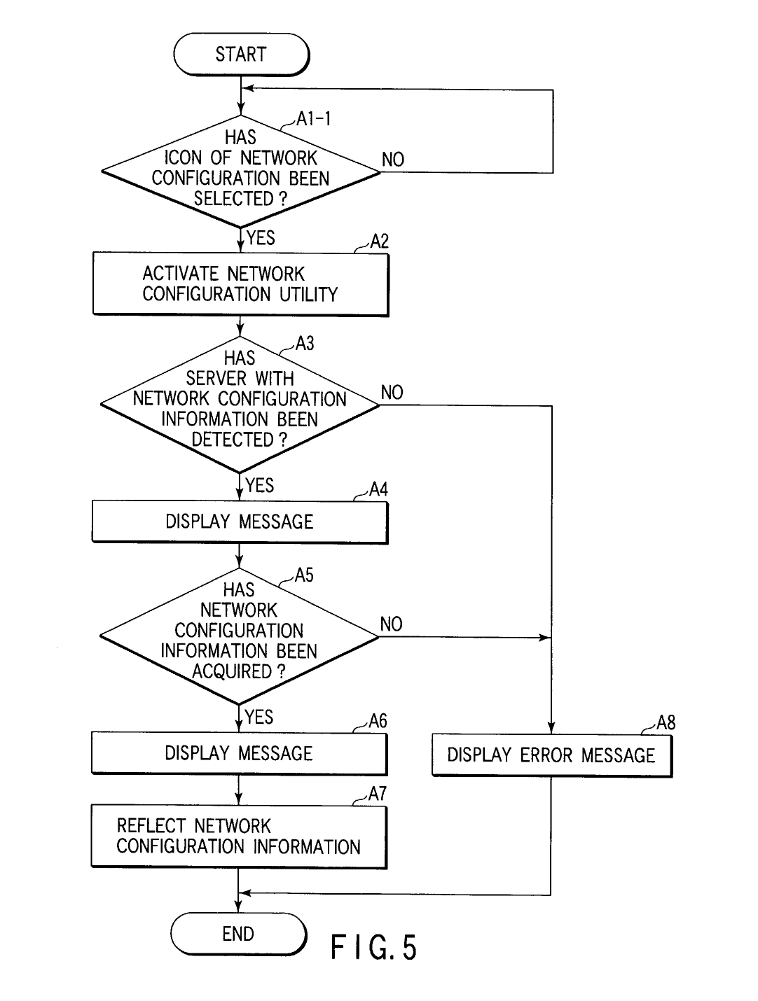

A further embodiment of the invention will now be described with reference to the flowchart shown in FIG. 5. According to the embodiment of the present invention illustrated by FIG. 5, an icon of a network configuration utility program is selected from a startup menu of the personal computer 1, thereby automatically acquiring network configuration information.

Specifically, when the personal computer 1 is connected to the network 12 and the user wishes to acquire network configuration information, the user clicks or otherwise selects the icon of the network configuration utility program from the start-up menu by means of, for example, a mouse. As shown in step A1-1 in FIG. 5, the control device 22 determines whether the icon of the network configuration utility program on the start-up menu has been selected. If the icon has been selected, the network configuration utility program is activated, as shown in step A2.

If the network configuration utility program is activated in step A2, the same process as that described above in relation to the flowchart shown in FIG. 3 occurs, and the network configuration information is automatically acquired from the network server 13.

Thus, according to the embodiment of the present invention illustrated by FIG. 5, an icon of the network configuration utility program on the start-up menu is selected by means of, for example, the mouse, and the network configuration information is automatically acquired from the network server 13. The embodiment of the present invention illustrated by FIG. 5 is applicable to both wired and wireless networks.

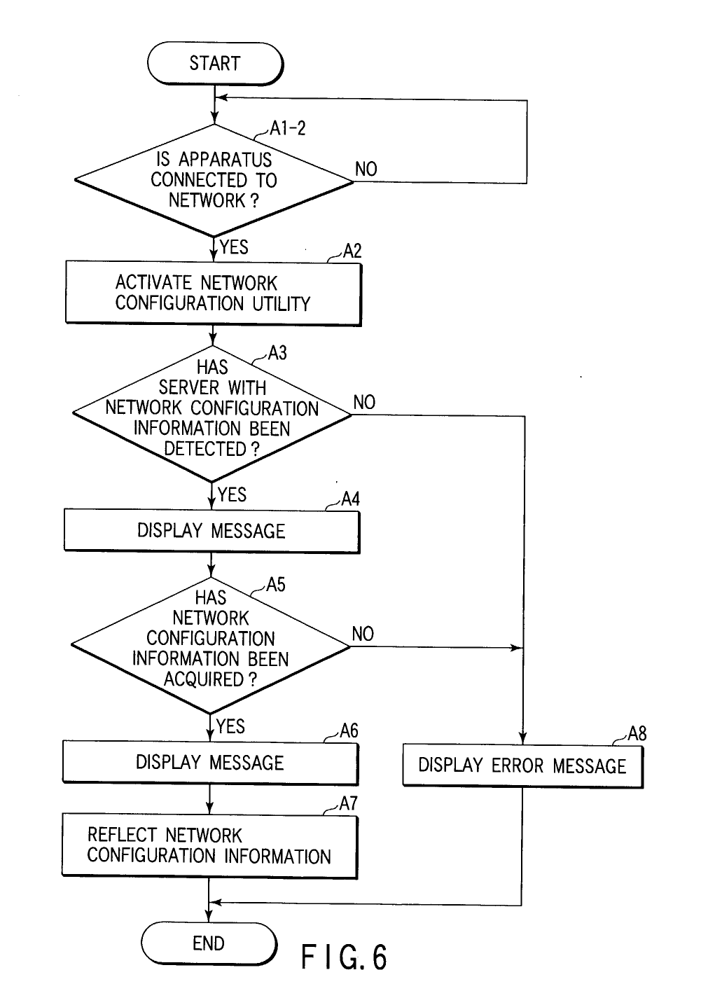

Another embodiment of the invention will now be described with reference to the flowchart shown in FIG. 6. According to the embodiment of the present invention illustrated by FIG. 6, when the personal computer 1 using a wired network such as a wired LAN is initially connected to the network 12 over the network cable 11, the connection is detected and network configuration information is automatically acquired.

A packet, which is obtained when the personal computer 1 has been connected to the network 12, is sensed to determine whether the personal computer 1 is connected to the network 12. Specifically, in the network control device 23, a packet-receiving unit determines whether a packet has been sent from some other personal computer to the network connection terminal 9 of the personal computer 1 (step A1-2). If the packet has been detected, physical connection between the personal computer 1 and network 12 is determined to exist, and the network configuration utility program is activated in the next step A2.

If the network configuration utility program is activated in step A2, the same process as that described above in relation to the flowchart shown in FIG. 3 occurs, and the network configuration information is automatically acquired from the network server 13.

In the embodiment of the present invention illustrated by FIG. 6, initial connection between the personal computer 1 and network 12 is determined based on the presence/absence of the packet. If the packet is detected, the network configuration utility program is automatically activated. Thus, the network configuration information is automatically acquired simply by connecting the personal computer 1 to the network 12.

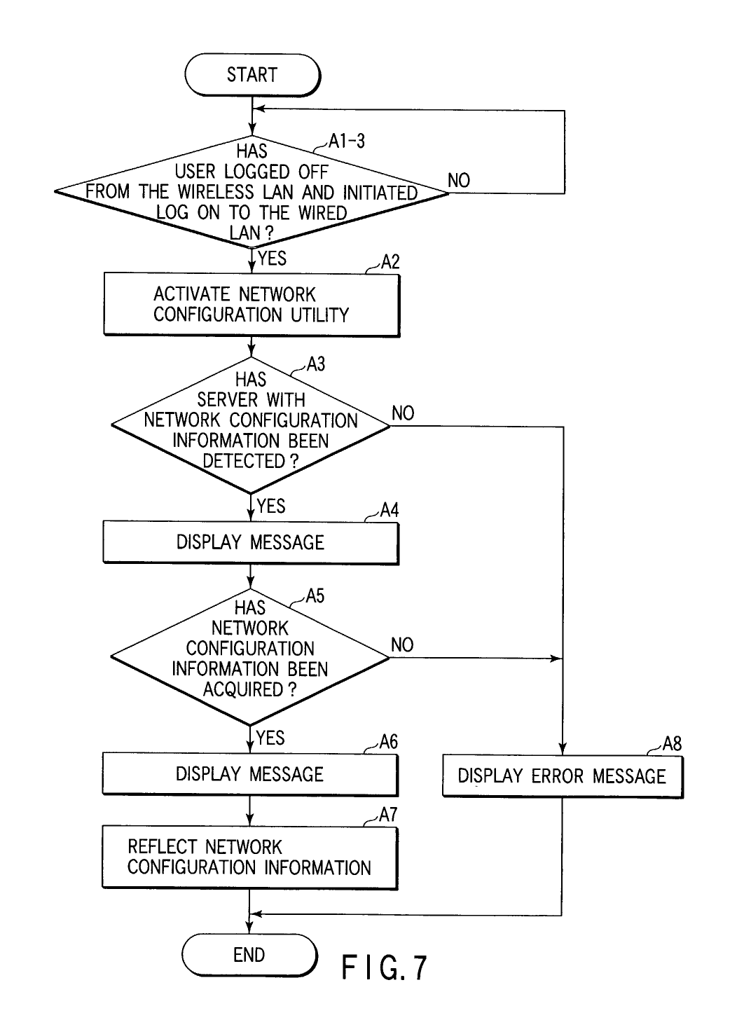

A further embodiment of the invention will now be described with reference to the flowchart shown in FIG. 7. According to this embodiment of the invention, the personal computer 1 may be connected to two or more different networks at the same time. As an example, it is assumed that the personal computer 1 is connected to both a wired LAN (wired network) and a wireless LAN (wireless network), and that the user of the personal computer 1 is currently logged on to the wireless LAN. The user of personal computer 1 now desires to log off from the wireless LAN and log on to the wired LAN.

According to the present embodiment, while the user is logged on to the wireless LAN, the network control device 23 checks to determine whether or not this status changes, i.e., whether or not the user logs off from the wireless LAN and initiates log on to the wired LAN, as shown in the flowchart of FIG. 7 (step A1-3). If the user of personal computer 1 logs off from the wireless LAN when switching from the wireless LAN to the wired LAN (i.e., when logging off from the wireless LAN and initiating log on to the wired LAN), the network control device 23 detects this in step A1-3 and activates the network configuration utility program (step A2).

If the network configuration utility program is activated in step A2, the same process will occur as that discussed in relation to the embodiment illustrated in the flowchart shown in FIG. 3, and the network configuration information will be automatically acquired from the network server 13.

Thus, in the embodiment of the present invention illustrated by the flowchart shown in FIG. 7, while the user of personal computer 1 is logged on to the wireless LAN, the network control device 23 checks to determine if the user logs off from the wireless LAN and initiates log on to the wired LAN. If the network control device 23 detects that the user has logged off from the wireless LAN and initiated log on to the wired LAN, the network configuration utility program is automatically activated. Therefore, the network configuration information can automatically be acquired simply by the user logging off from the wireless LAN and initiating log on to the wired LAN.

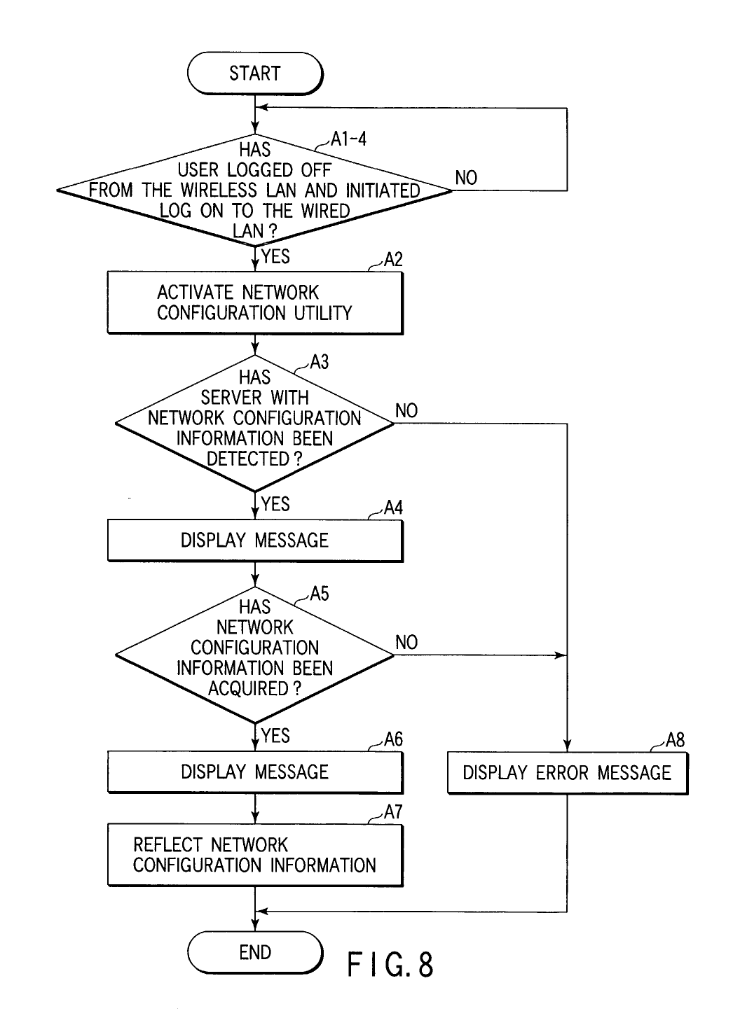

A further embodiment of the invention will now be described with reference to the flowchart shown in FIG. 8. As in the previously described embodiment of the invention, the personal computer 1 may be connected to two or more different networks at the same time. As an example, it is assumed that the personal computer 1 is connected to both a wired LAN and a wireless LAN, and that the user of personal computer 1 is currently logged on to the wired LAN. The user now desires to log off from the wired LAN and log on to the wireless LAN.

According to the present embodiment, while the user is logged on to the wired LAN, the network control device 23 checks to determine whether or not the user logs on to the wireless LAN, as shown in the flowchart of FIG. 8 (step A1-4). When the user switches from the wired LAN to the wireless LAN (i.e., when logging off from the wired LAN and initiating log on to the wireless LAN), the network control device 23 detects this in step A1-4 and activates the network configuration utility program (step A2).

If the network configuration utility program is activated in step A2, the same process will occur as that discussed in relation to the embodiment illustrated in the flowchart shown in FIG. 3, and the network configuration information will be automatically acquired from the network server 13.

Thus, in the embodiment of the present invention illustrated by the flowchart shown in FIG. 8, while the user of personal computer 1 is logged on to the wired LAN, the network control device 23 checks to determine if the user logs on to the wireless LAN. If the network control device 23 detects that the user has logged on to the wireless LAN, the network configuration utility program is automatically activated. Therefore, the network configuration information can automatically be acquired simply by the user logging on to the wireless LAN.

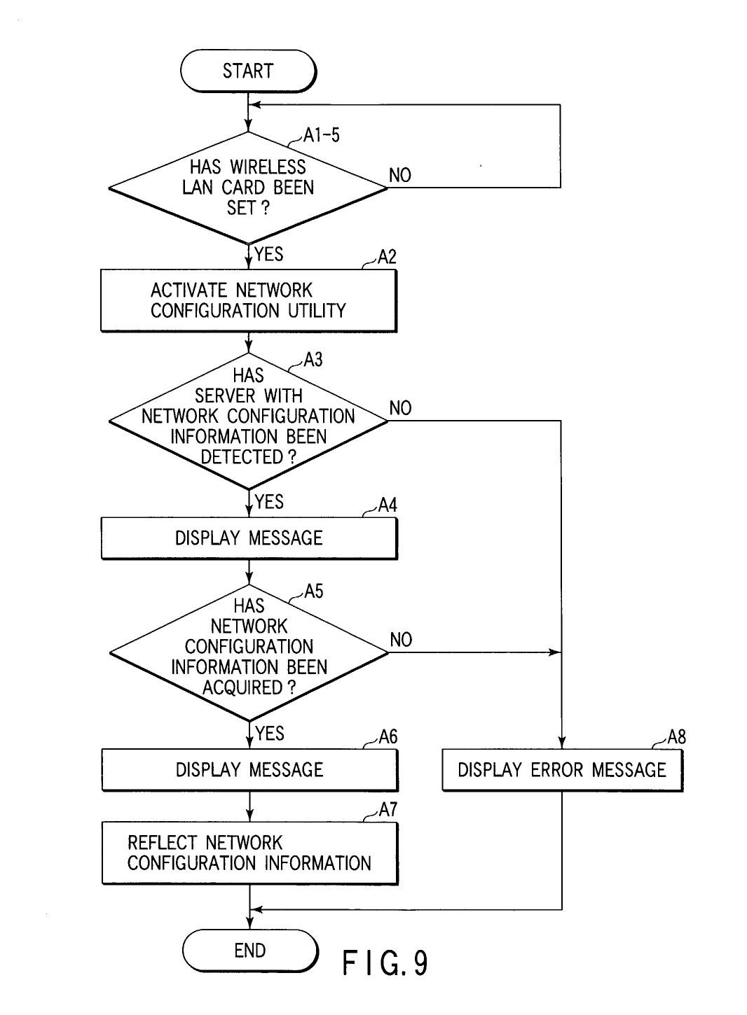

A further embodiment of the invention will now be described with reference to the flowchart shown in FIG. 9. According to the embodiment illustrated in FIG. 9, the personal computer 1 is provided with the function of connecting to a wireless network by inserting a network communication card, for example a wireless LAN card, in the card slot 8 of personal computer 1.

The network control device 23 checks to determine whether or not the wireless LAN card has been inserted in the card slot 8 (step A1-5). If the user inserts the wireless LAN card in the card slot 8 of personal computer 1, the network control device 23 detects this in step A1-5 and activates the network configuration utility program (step A2).

If the network configuration utility program is activated in step A2, the same process as that described above in relation to the flowchart shown in FIG. 3 occurs, and the network configuration information is automatically acquired from the network server 13.

In the embodiment of the present invention illustrated by FIG. 9, the network configuration information for logging on to the wireless network can automatically be acquired from the network server simply by inserting the wireless LAN card into the card slot 8.

According to the above described embodiments, the network information acquisition device 231 is provided in the network control device 23. When an operation relating to the network connection has been performed, for example, when the instruction button 7 or the icon of the network configuration utility program has been selected, or when the network cable 11 has been connected, these operations are detected and the network configuration information is acquired from the network server 13. Thus, the network configuration information can be obtained by very simple operations.

In addition, according to the above described embodiments, real-time information about the progress (i.e., acquisition/non-acquisition of the network configuration information) of the automatic network configuration acquisition process is advantageously displayed to the user on the display screen 33.

Thus, there is provided an information processing apparatus and a network configuration method which enables a user to easily acquire network configuration information and informs the user of the current state of the acquisition process.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

For example, a personal computer has been described as the information processing apparatus. Alternatively, the information processing apparatus may simply be an e-mail apparatus or an Internet browser apparatus. Moreover, embodiments of the present invention may also be implemented as a computer readable recording medium on which a program for allowing a computer to execute predetermined instructions or allowing the computer to function in a predetermined manner, is recorded.

What is claimed is:

1. An information processing apparatus for performing communication via at least one network and acquiring, from a server connected to the at least one network, configuration information for utilizing the at least one network, the apparatus comprising:
an instruction unit configured to generate an acquisition instruction for acquiring the configuration information upon an operation by a user;
a search unit configured to detect the server on the at least one network according to the acquisition instruction; and
an acquisition device configured to acquire the configuration information from the detected server.

2. The apparatus according to claim 1, wherein the instruction unit has an instruction key switch selectable for generating the acquisition instruction.

3. The apparatus according to claim 2, wherein the instruction key switch is selected after power has been supplied to the information processing apparatus.

4. The apparatus according to claim 1, wherein the instruction unit comprises a display unit configured to display an icon selectable for initiating acquisition of the configuration information, and a detection unit configured to generate the acquisition instruction in response to selection of the icon.

5. The apparatus according to claim 1, wherein the instruction unit comprises a detection unit configured to detect initial connection to the at least one network and generate the acquisition instruction upon detecting the initial connection to the at least one network.

6. The apparatus according to claim 5, wherein the detection unit comprises a receiving unit configured to receive a packet from the at least one network, and the detection unit detects an initial connection to the at least one network upon detecting that the receiving unit has received the packet from the at least one network.

7. The apparatus according to claim 1, wherein the instruction unit comprises a detection unit configured to detect, when the apparatus is logged on to a wireless network, a condition wherein the apparatus is logged off from the wireless network and log on to a wired network is initiated, and wherein the instruction unit generates the acquisition instruction when the condition has been detected.

8. The apparatus according to claim 1, wherein the instruction unit comprises a detection unit configured to detect, when the apparatus is logged on to a wired network, a condition wherein the apparatus logs off from the wired network and initiates log on to a wireless network, and the instruction unit generates the acquisition instruction when the condition has been detected.

9. The apparatus according to claim 1, wherein the instruction unit comprises a card detection unit configured to detect insertion of a PC card for network connection, and the instruction unit generates the acquisition instruction when the insertion of the PC card has been detected.

10. The apparatus according to claim 1, further comprising a display unit configured to display at least one of a current state of a server detection process and a result of the server detection process.

11. The apparatus according to claim 1, further comprising:
a detection unit configured to detect a current state of acquisition of the configuration information; and
a display unit configured to display the current state of acquisition of the configuration information detected by the detection unit.

12. A network configuration method for an information processing apparatus for performing communication via at least one network and acquiring, from a server connected to the at least one network, configuration information for utilizing the at least one network, the method comprising:
generating an acquisition instruction for acquiring the configuration information upon an operation by a user;
detecting the server on the at least one network according to the acquisition instruction; and
acquiring the configuration information from the detected server.

13. The method according to claim 12, wherein the acquisition instruction is generated by selecting an instruction key switch.

14. The method according to claim 12, wherein the acquisition instruction is generated by selecting an icon displayed on a display unit.

15. The method according to claim 12, wherein the acquisition instruction is generated upon initially detecting connection to the at least one network.

16. The method according to claim 12, wherein when the apparatus is logged on to a wireless network, the acquisition instruction is generated when the apparatus is logged off from the wireless network and log on to the wired network is initiated.

17. The method according to claim 12, wherein when the apparatus is logged on to a wired network, the acquisition instruction is generated when the apparatus logs on to a wireless network.

18. The method according to claim 12, wherein the acquisition instruction is generated when insertion of a PC card for network connection has been detected.

19. The method according to claim 12, further comprising displaying at least one of a current state of a server detection process and a result of the server detection process.

20. The method according to claim 12, further comprising:
detecting a current state of acquisition of the configuration information; and
displaying the detected current state of acquisition of the configuration information.
